(19) United States
(12) Patent Application Publication
(10) Pub. No.: US 2004/0112516 A1
(43) Pub. Date: Jun. 17, 2004

(54) Method and apparatus for electric-charge adhering of thin release-layered plastic firlms to thin copper foil substrates and the like and improved products thereby produced

(75) Inventors: Martin J. Wilheim, New York, NY (US); Edward J. Alois, Andover, MA (US)

Correspondence Address: Rines and Rines, 81 North State Street, Concord, NH, 03301, US

(73) Assignee: Metallized Products, Inc.

(21) Appl. No.: 10/318,415

(22) Filed: Dec. 13, 2002

(51) Int. Cl. C09J 1/00; B32B 31/00

(52) U.S. Cl. 156/247; 156/344; 156/584

(57) ABSTRACT

An improved method of and apparatus for producing novel preferably thin plastic protective or masking film layer products for thin shiny copper foils and the like, as for PCB applications and the like, with an inner releasable film surface coating carrying a permanent electric-charge for adhering to the shiny foil surface, but with the opposite outer surface of the film being maintained uncharged and electrically neutral.

### FIELD

The invention relates to protecting contaminatable and damageable thin, clean and shiny (“drum-side”) substrate surfaces and the like—more particularly, but not exclusively, to thin copper and related foil surfaces, as required in printed circuit board (PCB) and related technologies, through the application to such substrate surfaces of release-layered plastic or similar films and the like that are adhered to such surfaces by substantially permanent electric-charge adherence techniques.

### BACKGROUND

The use of electric-charge adherence of the protective films to the copper or other substrates is described in copending U.S. patent application Ser. No. 10/186,866, filed Jun. 28, 2002 and assigned to Metallized Products, Inc.; the common assignee of the present application. As therein explained, in the printed circuit board industry, it is necessary that the thin soft and pliable smooth and shiny clean copper foil be protected as by such an adhered, but releasable, masking film or layer, from the depositing of airborne particulates and from marring; and that it also be buffered from pits and dents as from imperfect separator plates and the like. The foil, furthermore, is preferably somewhat stiffened and somewhat cushioned to withstand transit, slitting, sheeting and tooling processes, and specifically, the handling during the PCB processing. The adhered protective layer or film for certain processing purposes, moreover, must withstand high temperatures up to about 400° F. and endure up to about 700 psi of high laminating pressure, but then still be readily strippable from the copper foil to enable etching and photolithographic and other PCB surface processing. All this, moreover, with a critical film release from the copper foil that leaves absolutely no residue on the pristine shiny smooth foil surface and no marking or pattern-embossing effect on the foil surface.

Prior to the electric-charge-adhered protective film techniques of said copending application, approaches to solve the above problem had involved the use of preferably polyester and other insulating plastic coating layers, adhesively attached to the electrically conducting foil as in our prior U.S. Pat. No. 4,753,847, marketed by said assignee under the trademark PACOTHANE. Adhesives, however, always raise the problems of cost, curing time, surface uniformity and residues on the foil or other substrate, among others. Other prior approaches to the adherence of protective layers to copper foils or the like, are also described in our later U.S. Pat. Nos. 5,948,526 and 5,989,377. The Sentrex Company has offered a product under the mark COPPERGARD using a 3-mil low-density polypropylene with 1.25-mil linear low-density polypropylene attached on both sides of the copper foil, and has obtained U.S. Pat. No. 6,280,851. A further U.S. Pat. No. 5,120,590 of Gould Inc. has also proposed protective layers for an electrodeposited metal foil; and a Mitsui Mining U.S. Pat. No. 5,942,314 discloses ultrasonically weld-bonding of aluminum to the copper. The RS Services Company in its product SC, spot-adheres stainless steel to the copper. One such “protected copper” product comprises laminations of copper to two sides of an aluminum sheet (for example 0.15/0.20″ thin). Such constructions using aluminum as a separator plate, however, forbid the use of the preferred stainless steel separator plates that are employable with the also more cost-effective approach of the present invention.

The substitution of electric-charge protective film adherence technology was stimulated by questioning and exploring whether suitable protective layers could be releasably attached to the copper foil without resorting to the use of the prior conventional physical adhering techniques—adhesives, bonding, etc.—i.e. using instead, the temporary adhesion effected by permanent electrical charges. Charge-adhesion had been long used for other purposes, including more recently in the graphic arts industry, primarily, as for providing compositor printing sheets comprising a backing and a printing sheet including a plastic electret sheet subjected to electrostatic fields under high voltage corona arc discharge, as disclosed, for example, in the Permacharge Corporation U.S. Pat. No. 6,284,339 and also in U.S. Pat. Nos. 5,989,685 and 5,904,985. Such, however, involves very different products, problems, requirements and processing than those of the printed circuit board field and of thin metal foils and the like, so that the electrical charge-adhesion concept did not at first seem applicable to the radically different products, needs and conditions of PCB manufacture. Questions arose, for example, as to whether an electrostatically generated electric-charge adherence could be strong enough; how long could the charge last; what does humidity do to the charge; would the charge deleteriously affect the protective layer release performance; would the charge impact the copper foil in the laminating process; and would the charge hold during the rigorous handling and processing conditions of PCB operations, etc.?

Our early attempts, indeed, to use the electrostatic electric-charge process with its conventional corona or arc treatment as used in the graphic arts industry for its other purposes, indeed, failed to meet the PCB requirements. Modification of the conventional electrostatic electric-charge approach, including in some instances, elimination of corona treatment and the use preferably of select polyester plastic protective electrically insulating layers and the like, enabled improved charge adherence (for example, 232 grams of force in one test), and ultimately led to the successful adaptation and use of this charge-adhesive technique for these purposes, as described in said copending application. Applicant's said assignee markets such polyester plastic protective layers under the before-mentioned trademark PACOTHANE, and when electrostatically charged, under the mark PACOMASK—such names also being hereinafter used.

In certain commercial applications, however, the use of the charged insulating protective layers has sometimes been found to introduce undesirable external adherence and other problems.

The protective or masking charged film layers, such as said PACOMASK layer(s), particularly for relatively wide widths of copper sheets, may be applied (“married”) to the copper sheets in at least two ways.

One is at the copper slitter/rewinder (FIG. 2) where two unwind stands may be used—one carrying a roll of the PACOMASK web, and the other, a roll of the copper foil. The mask may be adhered or married to the copper foil at this point, and the married or protected roll(s) then fed to a sheeting machine for paneling into predetermined desired sizes—possibly, also, with two rolls of protected or masked copper foil sheeted simultaneously as in later-described FIG. 6.

A second approach, also hereinafter fully described in connection with FIG. 7 hereof, is to adhere the protecting or masking charged PACOMASK roll material to the copper foil roll material at the sheeter station with its pair of unwind stands. A roll of PACOMASK placed on one of the unwind stands may then be fed to meet a copper foil roll carried by the other stand.

With either of these techniques, however, the previously mentioned deleterious external adherence problems can occur, as follows:

1. Since the charged plastic PACOMASK layer(s) or the like carry electrostatic charges on both of their opposite external surfaces, both surfaces have an inherent charge attraction to metal—the inner charged surface, indeed, attaching, as is desired, to the shiny surface of the copper foil. But, in some circumstances, the outer opposite charged surface that is not adhered to the copper foil, provides external attraction to the metal parts of the sheeting machine as it is being sheeted, causing “jam-ups”.

2. The charge attraction on such opposite surface of the PACOMASK protecting layer may also cause the unprotected surface of the next sheet being sheeted, to find an affinity for the protected sheet of copper below, again causing jams and sometimes causing wrinkles.

3. Following the sheeting, furthermore, when picking up or handling a single sheet of masked or protected copper foil, the mask or protection layer on the sheet below in a stack, finds attraction for the unprotected copper surface of the sheet above, and tends to move with it or follow it.

4. The charge attraction on the external opposite surface of the PACOMASK layer, furthermore, has sometimes been found to attract air borne dust and the like.

Similar undesired attraction problems have sometimes been found to occur, also, in connection with some commercial uses of narrower width copper foil sheets for the printed circuit board shops and the like, which use three roll unwind stands, as later more fully detailed, and wherein copper foil rolls are placed on two outer stands and 2-plys of charge-protective film layers are assembled back-to-back and mounted on the inner in-line stand. The two films are adhered (“married”) to respective rolls of copper foil simultaneously, as hereinafter described in connection with FIGS. 8-10 of the drawings hereof.

Again, however, when, after sheeting, a single sheet of protected or masked copper foil is to be handled or picked up, the charged protective film on the sheet below in a stack may be attracted to the unprotected metal surface of the sheet above, and can tend to move with it or follow it.

It is to the solution of these problems, accordingly, that the present invention is directed, with the solution or remedy residing, in one form, with providing a protective or masking plastic film, such as a PACOTHANE film stucture, that is charged only on one side or surface, and not on the opposite surface, as well.

This, in effect, polarizes the masking sheet so as to attract to the copper foil only on one surface.

In another form of polarization, one or more strips or lanes of pressure-sensitive adhesive are applied on only the one PACOMASK surface that is to adhere to the copper foil in order to cause only that surface to have an affinity therefor.

The details of these polarizing solutions are fully described hereinafter.

### OBJECTS OF INVENTION

A primary object of the invention, accordingly, is to provide a new and improved method of and apparatus for electrostatic electric-charge adherence of plastic and related copper-foil-protecting or masking layers, (including those formed as by electron-beam or other curing techniques and by high pressure laminating procedures), to PCB smooth and shiny thin copper foil surfaces and the like, and with inherent capability of readily strippable or peel-off release of the protecting layer(s) without residual contamination or other marring of the copper foils surface(s) as earlier described, and further with insuring that only the one surface of the protecting layer that is to be adhered to the shiny copper foil surface is polarizingly charged.

Another object is to provide such a novel method, apparatus and new products produceable thereby, wherein the polarization is aided by pressure-sensitive (electrically charged) adhesive strips or lanes, preferably along one or both marginal side edges thereof.

Still another object, more generally, is to provide novel plastic release-coated masking layer products for copper foil surfaces and the like, bearing an attracting charge along only one side or surface to be adhered to the foil, and with the opposite side or surface electrically neutral or uncharged.

A further object is to provide such novel polarized electrically charged plastic protective layer products further particularly adapted to be wound and unrolled.

Still a further object is to provide novel protected foil assemblies and the like having such polarized electrically charge-adhered protective layers that are readily releasable.

Other and further objects will also be described hereinafter and will be more particularly delineated in the appended claims.

### SUMMARY

In summary, from one of its viewpoints, particularly in the application to thin copper foil and the like, the invention embraces a method of protecting a smooth high finish shiny thin conducting copper foil with a protective masking insulating plastic film pre-treated over at least one of its opposite sides with a release surface, that comprises, electrostatically permanently charging said release surface while maintaining the opposite film side uncharged or neutral; laminating the film to the foil to charge-adhere the film release surface against the shiny foil; and subsequently, after the protection is no longer required, releasably stripping the film from the foil.

Preferred and best mode embodiments are later detailed.

### DRAWINGS

The invention will now be explained in connection with the accompanying drawings, illustrative of the exemplary application of the invention to copper foil and the like, and in which FIG. 1 is a sectional view of a preferred copper foil-protected product of the invention in accordance with the teachings of said co-pending application;

FIG. 2 is a schematic side elevation of an apparatus and technique for creating the permanently charged protective plastic film layers or sheets for products as in FIG. 1, and in web roll form.

FIGS. 3A and 3B are top plan and transverse sectional views of a novel preferred type of plastic film (actually composite) of the invention, that enables the attainment of its new foil-protection or masking results in charge-adhesion along its inner charged release surface to a shiny copper foil surface, while maintaining its exposed outer surface electrically uncharged or neutral;

FIGS. 4A and 4B and 5A and 5B are similar views showing, also, the assistance of single and double-edge pressure-sensitive strips or lanes in the foil-adhering operation;

FIGS. 6 and 7 are schematic side elevations of suitable sheeter apparatus for a pair of film-protected copper foil rolls of the invention, being useful, respectively, with pre-married protective film and foil, and alternatively with the laminating or marrying within the apparatus;

FIGS. 8, 9 and 10 are similar views of different nipping configurations in PCB sheeter apparatus for adhering each of 2-ply protective film webs to two copper foil webs at the same time; and

FIG. 11 diagrams a suitable slitter/rewinder for the purposes of the invention.

### PREFERRED EMBODIMENTS OF THE INVENTION

### The Generic Protective or Masking Insulating Film Layer(s)

Referring to FIG. 1, a preferred illustrative underlying product made in accordance with the method and apparatus of the invention of said co-pending application, is shown in longitudinal cross-section, comprising a thin high gloss smooth copper foil or sheet 1, useful for the before-described PCB and related fields, say of the order of from 0.00019″ to 0.0005″ in thickness, provided with a thin upper plastic protective or masking composite film 2 adhered to its shiny upper surface 1′. The film is illustrated as of the previously described polyester plastic film laminate type 2 having thin cured preferably acrylated oligomer resin release coatings 2′ and 2″ adhered on the upper and lower surfaces, as described in our previously referenced U.S. Pat. No., 4,753,847, and using the chemical compositions and electron-beam or other curing and laminating processing described therein and in the other later-referenced patents. With this two-sided release coated laminate, the film 2 may, for example, be a 0.00092 inch PET film, with the overall release coated structure 2-2′-2″ having a thinness of about 0.0016 inch. As another example, a 0.000248 inch PET film with such two-sided release coating may have a final thinness of about 0.0012 inch. A suitable range of such film thickness is from about 0.00048 inch to 0.003 inch.

While applying chemistry pre-treatment for the smooth cured release coating surfaces of the film, such as for the coating surface 2″ adjacent the corresponding smooth shiny copper foil surface 1′, the outer or upper coating surface 2′ may, in some instances, be formed with a somewhat rougher surface for handling advantages in the sheeting processing of the film-protected foil; more specifically, wherein one cut sheet may slide more easily over the next upon such rougher surface.

### The Electric-charge Attachment

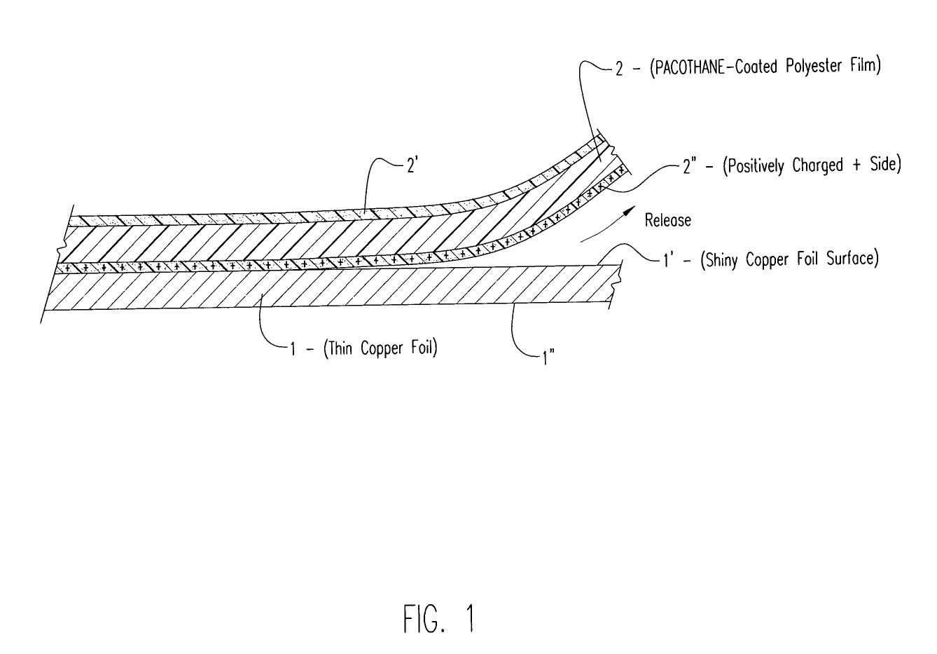

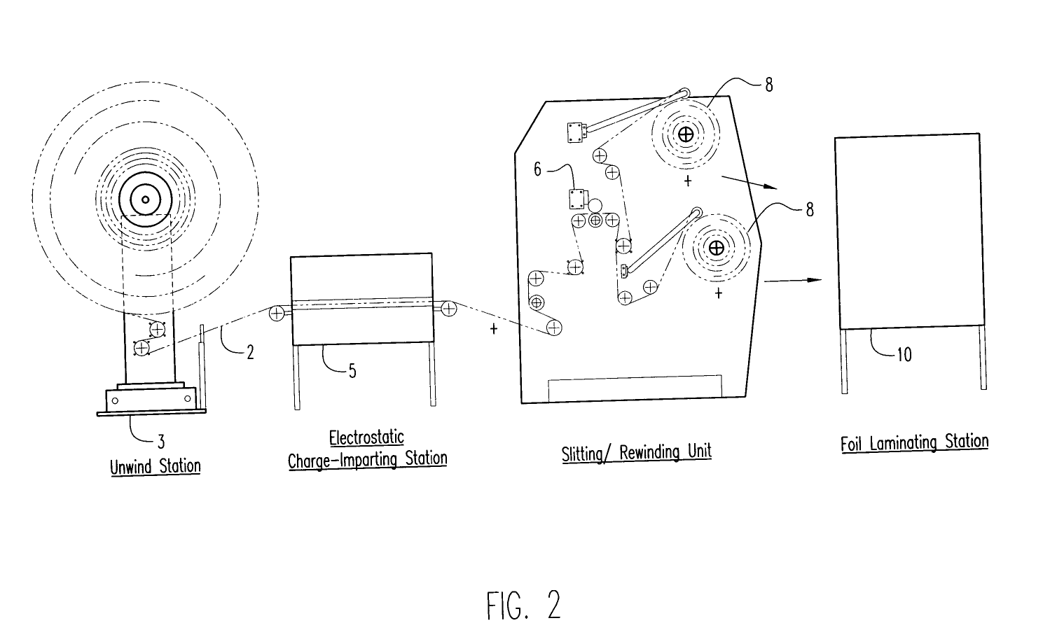

In practice, the insulating protective film laminate 2-2′-2″ (such as the before described PACOTHANE) is provided in rolls as at an unwind station 3 in FIG. 2, for unwinding and feeding to and through a web electrostatic charge-imparting station 5 to permanently positively charge the film to act as an electret (indicated by the plus signs +) as, for example, in the manner taught in U.S. Pat. Nos. 6,143,255 and/or 5,686,050. The required releasable charged protective film is then conveyed through one or more slitters 6, with the resulting slit sheets thereof conveyed to a corresponding plurality of rewinding rollers 8 to provide charged-film rolls to respective well-known copper foil-laminating stations 10 to produce the protected foil.

Thus, in the laminated protected foil product of FIG. 1, the lower surface 2″ of the protective film laminate is shown electric-charge-adhered (+), uniformly to the upper surface 1′ of the thin copper foil 1, in accordance with the before-described technique of the said co-pending application. The smooth surface 2″ prevents the undesirable effect of the embossing of a pattern on the shiny copper foil surface 1′.

Tests have shown, as earlier alluded to, that charge-adhesion of these preferred polyester plastic protective or masking films to thin copper foil, unlike with prior customary corona-arc charging procedures used for the graphic art type of very different products, has proven more successful in some tests without the use of any corona treatment, and also then without at all disturbing the release properties of the protective film. Release or peel-off forces or strength of less than about 25 grams per lineal inch are attainable. The stripping or release of the protective film from the copper foil surface 1¹ is schematically shown to the right in FIG. 1.

This technique enables providing permanently charged insulative thin protective or masking plastic film rolls to the PCB and copper clad laminates for lamination-charge-adherence to the copper foil sheets. The PCB copper clad laminate manufacturers use the protected copper in their lay-up of laminating components. The components are pressed under the before-mentioned temperatures/pressures/time to provide a so-called “C-staged” or cured laminate, say, for example, in relatively wide 36″×48″ sizes or larger, that are then cut into, for example, useable, narrower 18″×24″ laminates for the PCB shop—all protected by the charge-adhered film layer. For the chemistry of the polyester preferred release coated pre-treated protective or masking PACOTHANE films previously described, moreover, (and other plastic types as well, as later described), the protective composite layer shown 2-2′-2″ is made substantially or nearly transparent, so that undesirable defects on the protected copper can be readily seen—a great advantage of the preferred products of the invention.

When the printed circuit board shop is ready to use the laminates, they strip or peel off the protective film and then proceed to drill or punch holes, electroplate, image, etch and print, etc., and upon the same pristine, clean, smooth, unmarred and residue-free surface of the original pristine copper foil that existed before the application of its protective layer(s). After printing and etching, the PCB shop generally produces a multi-layered laminate involving the etched panel with impregnated glass resin applied to two sides of the etched inner layer and copper and after that on both sides.

In other processes, the copper foil may be used in narrower rolls or sheets, as before mentioned, supplied by the copper foil manufacturer with the charge-adhered protective masking film layer applied to ensure the cleanliness of the copper surface(s) (½ or 1 ounce copper, for example). Before such employment in this lay-up or lamination process, moreover, all components may be punched or drilled with registration-keeping holes. Then, multilayered multiples of the components, separated by stainless steel plates, are inserted in a press and laminated at high temperature and pressure and over several hours of time for curing, as earlier described. The charge-adhered protective film layers are then stripped from the copper for further processing steps. Such are described, for example, in the earlier referenced U.S. Pat. No. 5,120,590.

The suitable charge-adhered protective thin PACOMASK films can serve to protect, even somewhat stiffen, and cushion, thin copper foils through all of the above-described handling and vigorous processing procedures and still protect the smooth, clean, unmarred shiny copper surface without mark or other physical or chemical residue whatsoever—and still retain the required range of release or peel-off properties.

While preferred plastic polyester thin film compositions have been stressed as best mode embodiments, other plastic films and even appropriately treated paper are also usable, as described in said co-pending application, with varying degrees of usefulness; among them, polypropylene—particularly bi-axially oriented polypropylene—, polyvinylidine fluoride, polyethylene, TPX (polymethyl pentene) and co-extruded films with releasable surface properties, and silicone treated films. For the purposes of the present invention, however, though thin films are preferable (PACOTHANE), including charged films (PACOMASK) of the order of about 0.00048″/0.003″ and the like, they must not wrinkle or curl or partially detach after application to the foil. Other shiny clean substrate surfaces besides thin copper foil, moreover, may also benefit from these charge-adhered protective or masking film techniques.

### The Improvements of the Present Invention

As before explained, the fact that the protective or masking films attached to the copper foil are charged on both opposite sides or surfaces by the charging station 5 (FIG. 2), can give rise to the previously outlined deleterious effects sometimes caused by the attraction of the outer or exposed charged surfaces to external machinery parts, to adjacent sheets, and to dust, debris and other particles, among other problems. In addition to sticking to machine parts, furthermore, the external surface charge sometimes does not allow the sheets to be properly stacked.

The remedy for these problems provided by the present invention resides in the broad concept of limiting the charging of the protective or masking film to one side or surface, only; i.e. the surface that is to adhere to the shiny side of the copper foil. The opposite or external (or upper) surface of the protective or masking film is to be maintained electrically uncharged, neutral or “dead”—that is, the protective layer is polarized with only one positively charged surface and an opposing neutral, uncharged or electrically “dead” surface.

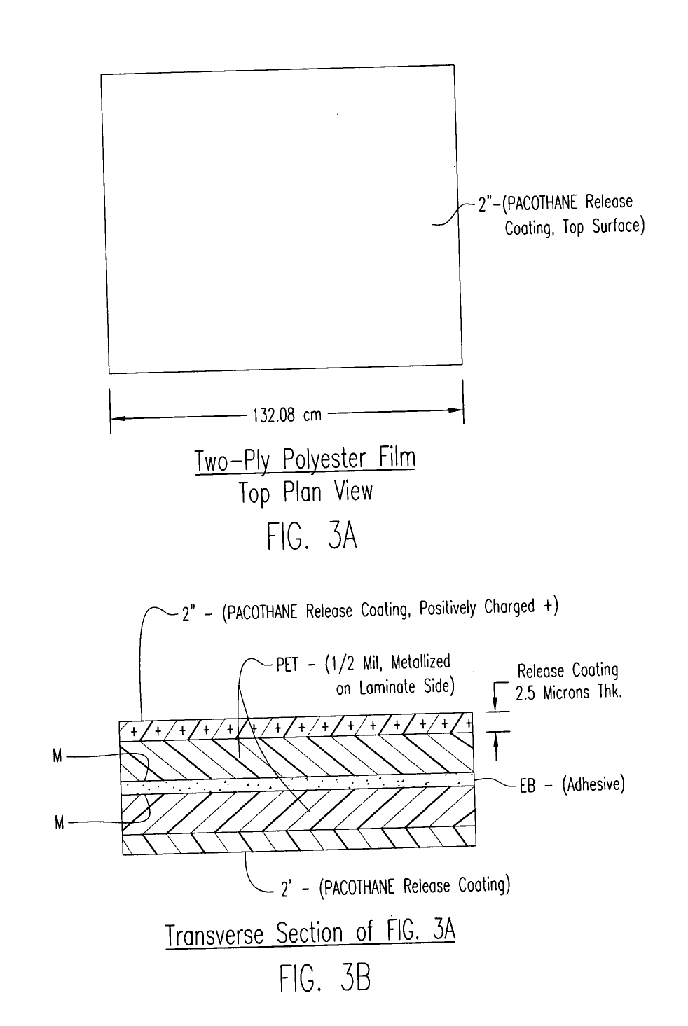

In accordance with a preferred embodiment of the invention, this result is attained by backing the release coating of the protecting layer with a conducting barrier or shielding surface, such as a metallized aluminum coating, that does not retain charge during the electrostatic charging of the protective film in the station 5 of FIG. 2. Thus, in FIG. 3B, the before-mentioned example of a polyester film 2 is illustrated as comprising a pair of such films (labeled “PET”) laminated together with, for example, an electron-beam curable adhesive (labeled “EG”). The inner surfaces of each of the films 2 are shown metallized, as by the before-mentioned aluminum coating (“M”) on their respective inner or laminated sides or surfaces. The two-ply polyester films 2-2 may, for example, be of the order of 0.48 gauge. If desired, one only of the films may be metallized with the aluminum or other metal interposed barrier coating. The overall laminated films will, for the illustrative thickness shown, have a total thickness of the order of approximately 1 mil (including the EB adhesive layer) and they may then be coated on both sides with the PACOTHANE release coatings 2′, 2″. The two-ply film is then electrostatically charged at station 5, (FIG. 2). The interposed conducting aluminum layer(s) shown at M will act as a conductive barrier or shield, such that the composite film accepts charge only on the outer release coating surface or side (the side facing the electrostatic charging unit), thereby achieving the desire goal of the invention—i.e. a protective or masking film or substrate having polarized external coating surfaces comprised of a charged attractive-force surface on one external or exposed side (2″) for enabling laminating charge-adherence to the copper foil, and an electrically neutral, uncharged or “dead” external or exposed outer coating surface on the opposing side (2′), that is thus not attracted to metal machine parts, does not “stick” to other sheets, and does not attract dust or other particles in the environment.

More specific and precise details of the preferred formulations and dimensions of the embodiment of FIGS. 3A and 3B will now be presented.

The polarized or one-side only “attractive” film (PACOMASK type) is a two-ply lamination with an overall thickness preferably of between 0.0014″ to 0.0017″ /37μ to 43μ. This lamination, as above described, is comprised of the combination of the two 0.00048″ /11.8μ PET films 2. As above stated, at least one has a vacuum-metallized aluminum deposition M [150 Angstroms] on one side, and a standard previously described PACOTHANE EB coating [1.5 to 3 lbs/30000 sq. ft./2.44 to 4.9 gms.] applied to the other. This 0.00048″ PET component (upper) is then EB-laminated to another 0.00048″ PET component (lower) that may or, may not have an aluminum coating on one side. The adhesive used to bond the two PET component films together maybe an EB adhesive such as Northwest Coatings, Inc. #15175L [1.5 to 3 lbs/3000 sq. ft./2.44 to 4.9 gms. Per M2].

It should be noted, however, that other adhesives mechanisms for bonding such as with UV adhesives, heat-activated adhesives, or conventional thermal cure adhesives may also be used. Similarly, as another example, PET films in the thickness ranges of 0.00025″/0.25μ to 0.00142″/36μ may also be used instead of the preferred embodiment using 0.00048″ PET. The vacuum-metallized deposition M on one or both thin film components of the lamination, furthermore, may be applied in thicknesses ranging from 50 to 500 Angstroms to provide the required metal-barrier layer.

The two-component films 2 described above were EB-laminated together after the application of the standard PACOTHANE EP coating. Depending upon the circumstance, however, the films may be laminated together first and then alternatively coated on each exposed side of the laminate with the PACOTHANE EB-curable coating. The film then receives the “charging process” at station 5, FIG. 2, with the charging apparatus located on the side of the laminate that is selected to be the “charged” surface—and this, irrespective of whether that laminated component [0.00048″ PET] has also been metallized or not.

### Supplementary (Charged) Adhesive Patterns

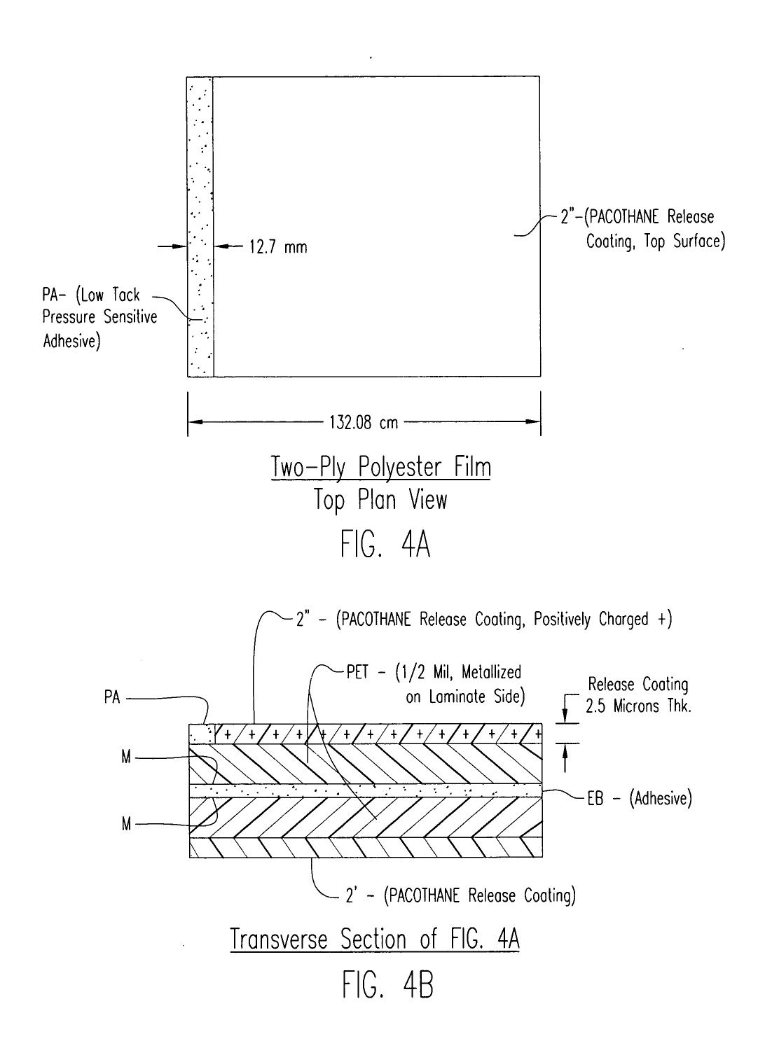

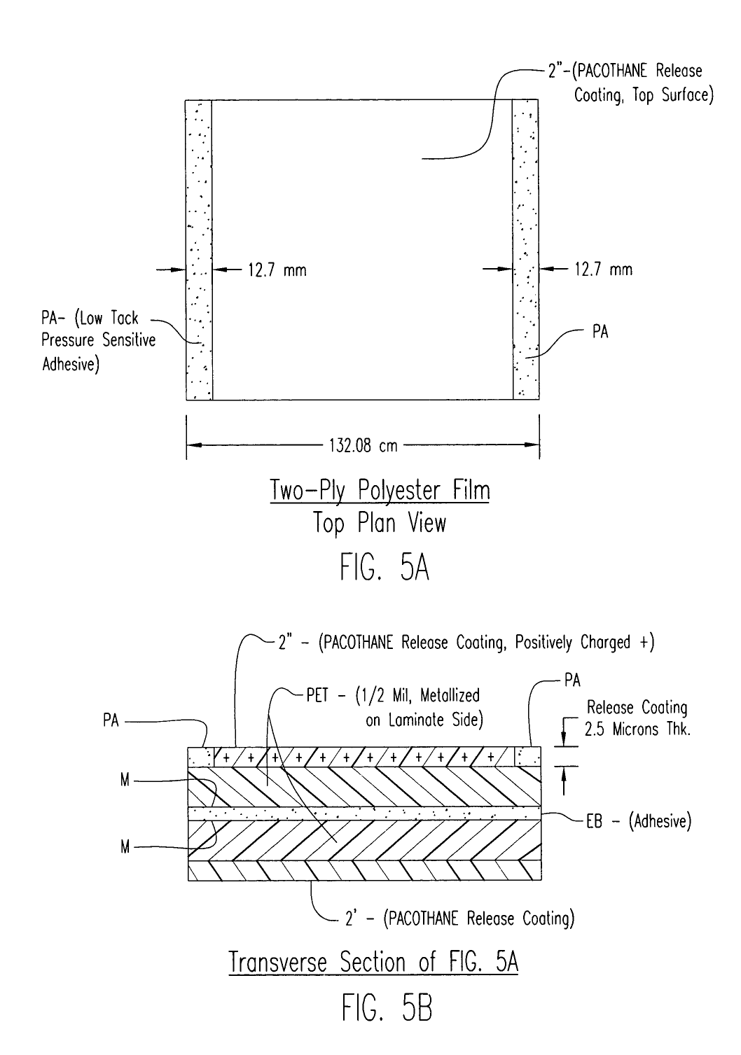

Further in accordance with the invention, and to assist or aid in the intended laminating attachment of the polarized charged-surface coating of the protective or masking film laminate to the designated shiny copper foil surface side, it has been found helpful, preferably to run the pressure-sensitive adhesive along the peripheral or marginal side edge(s) of the coated film, as shown at PA in FIGS. 4A and 4B, (though other patterns may also be used); or, if desired, along multiple (both) edges or other portions as in FIGS. 5A and 5B.

Fortuitously, it has been discovered that appropriate pressure-sensitive adhesives strips or patterns PA can be applied to the PACOTHANE release coating chemistry before described, and the adhesive strips will also become charged together with the coating in the electrostatic charger 5, and hold the charge. This, as before stated, further assists in the protective film surface sticking to the shiny side of the copper foil 1′, FIG. 1. Without this further polarizing assistance of the adhesive strips, indeed, the charged film sometimes has been found to have a tendency to become “confused” and to stick to the other rough side or surface 1″ of the copper foil 1.

This feature, moreover, provides the unique capability of applying a “patterned” pressure sensitive adhesive, in register with the release coatings, on the running edges of the protective film roll. Additionally, with the polarized one-side-charged film, a capability is provided of not only metallizing, but also laminating two films together.

The added pressure-sensitive adhesive lane(s), [for example, 1.5 to 3 lbs. Per 3000 sq. ft. 12.4 to 4.9 grms per M24] running preferably along the edge of the film, may be of a width in the range from about 0.125″ to 1″ /3 mm to 25.4 mm wide, on one edge (FIGS. 4A and 4B) or both edges (FIGS. 5A and 5B) of the protected PET-based masking PACOMASK type film. This pressure-sensitive adhesive lane(s) on the coating is preferably applied in register to the standard PACOTHANE EB coating (2′, 2″), and may be of exactly the same thickness.

An advantage of using the margin(s) of the film for the location of the pressure-sensitive strips or lanes PA resides in the easy trimming of the foil if an adhesive residue should be left, and in the ease of simultaneous application to the margin(s) of the protected film coating(s).

### Sheeter and Slitter/Rewinder Apparatus

It now remains to describe suitable sheeter apparatus for both wide and narrow forms of the laminated products of the invention, including for the adhering or marrying of the charged protective or masking film with the copper foil prior to the sheeting operation, or, if preferred, during the sheeting, and also specifically for PCB applications and/or other copper clad laminate use or the like.

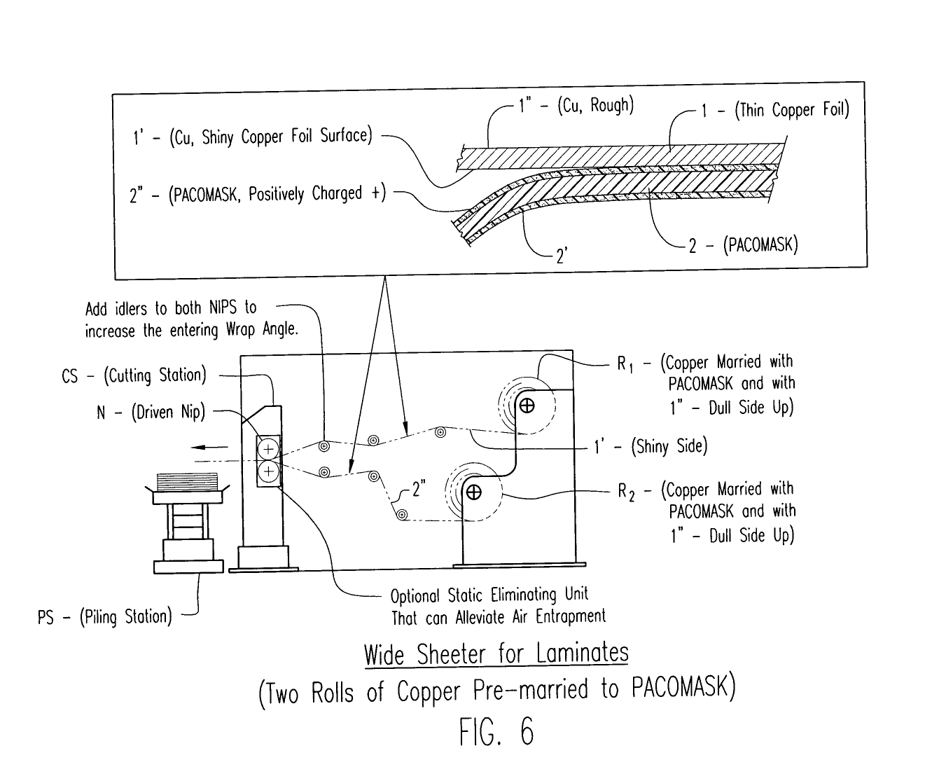

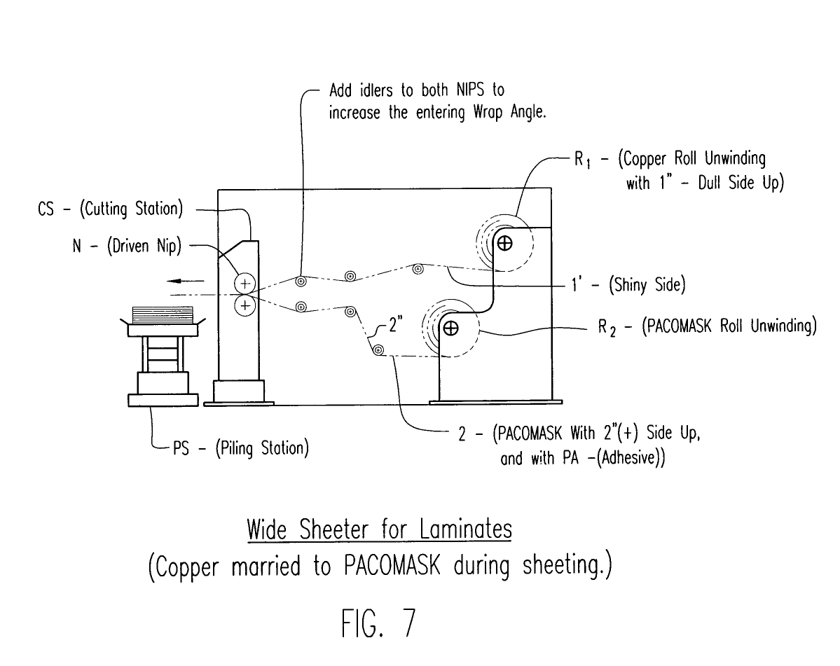

FIG. 6 illustrates the cutting into sheets of two rolls R₁ and R₂ of copper foil (1) laminating pre-adhered or pre-married to PACOMASK type one-surface charged protective or masking release films 2-2″, illustrated for relatively wide webs of the laminates. The two webs are shown separately entering the driven nip N at the cutting station CS, resulting in the stacking of laminate sheets at the pile station PS. The insert diagram box at the top of the drawing is a longitudinal section of the pre-married laminate webs 1, 2, showing illustrative separation at the left to illustrate the charged PACOMASK inner surface 2″ (“+”) of the laminate of FIG. 3B (or of FIGS. 4B or 5B, as desired) adjacent the shiny copper surface 1′. In FIG. 6, minimum tension should be used to prevent curl of the PACOMASK protective laminate. In operation, moreover, it has been found desirable to increase the wrap of both webs to approximately 30° on the driven nip rolls N, as shown.

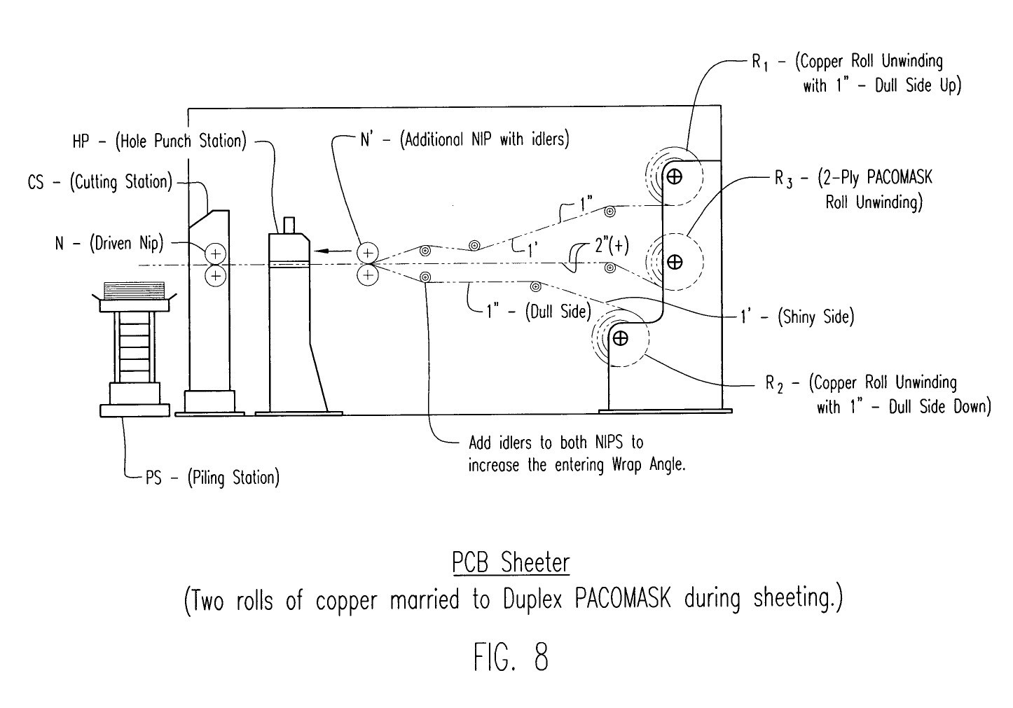

In FIG. 7, however, as another option above-mentioned, wide web sheeter apparatus for the laminate products is shown for the case where the copper foil 1 on roll R₁ and the PACOMASK web 2 on roll R₂, shown traveling with the shiny copper side 1′ down and the charged surface coating 2″ of the PACOMASK laminate facing up, are nipped together at station N; i.e. charge-adhered or married during the sheeting operation. In this instance, adhesive margin(s) PA of FIGS. 4A-4B or FIGS. 5A-5B are carried on the PACOMASK charged surface 2″ (+).

Should it be desirable, as earlier described, to protect two copper foil webs at the same time, as, for example, in PCB applications, resort may be had to the slitter apparatus of FIG. 8 wherein a 2-ply or duplex web of back-to-back PACOMASK sheets are unwound from intermediate roll R₃, and fed parallely with upper and lower copper foil webs 1 to the nipper station N and thence to the cutting station CS and piling station PS. The charged side or surface 2″ (+) of the upper PACOMASK web of the two-ply duplex web, faces upward to meet and charge-adhere to the lower shiny side 1′ of the upper copper foil web 1 during the nipping at N. Similarly, the charged lower surface 2″ of the lower PACOMASK ply, faces downward to meet and charge-adhere to the upper shiny side 1′ of the lower copper foil web 1. For PCB purposes, a hole punch station is provided at HP between a forward idler nip N′ and the driven nip N.

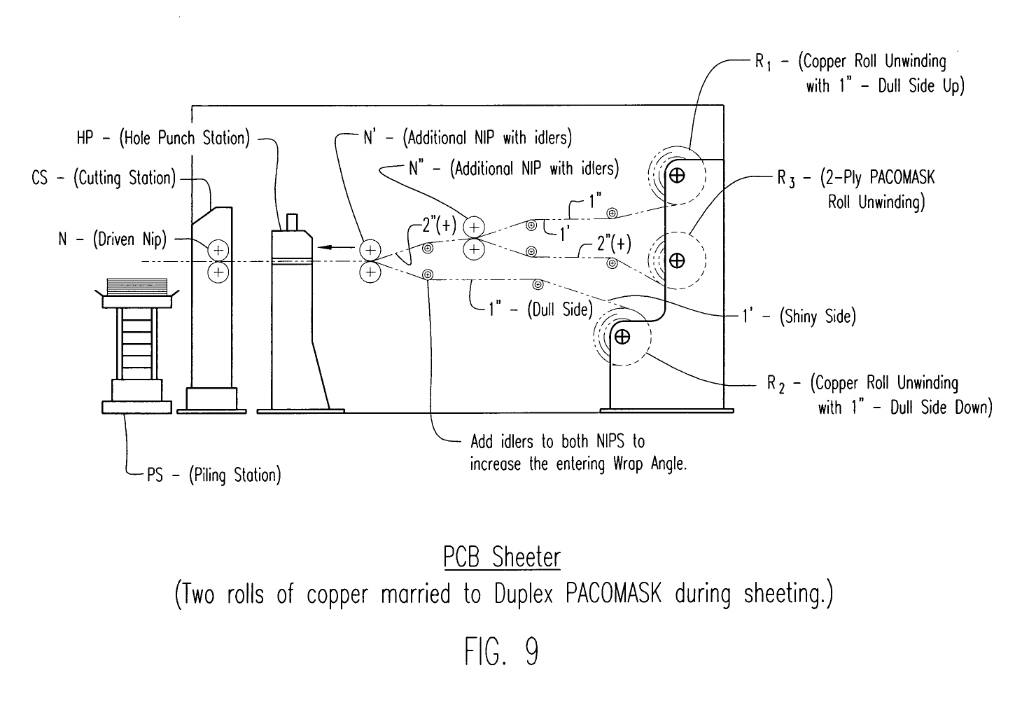

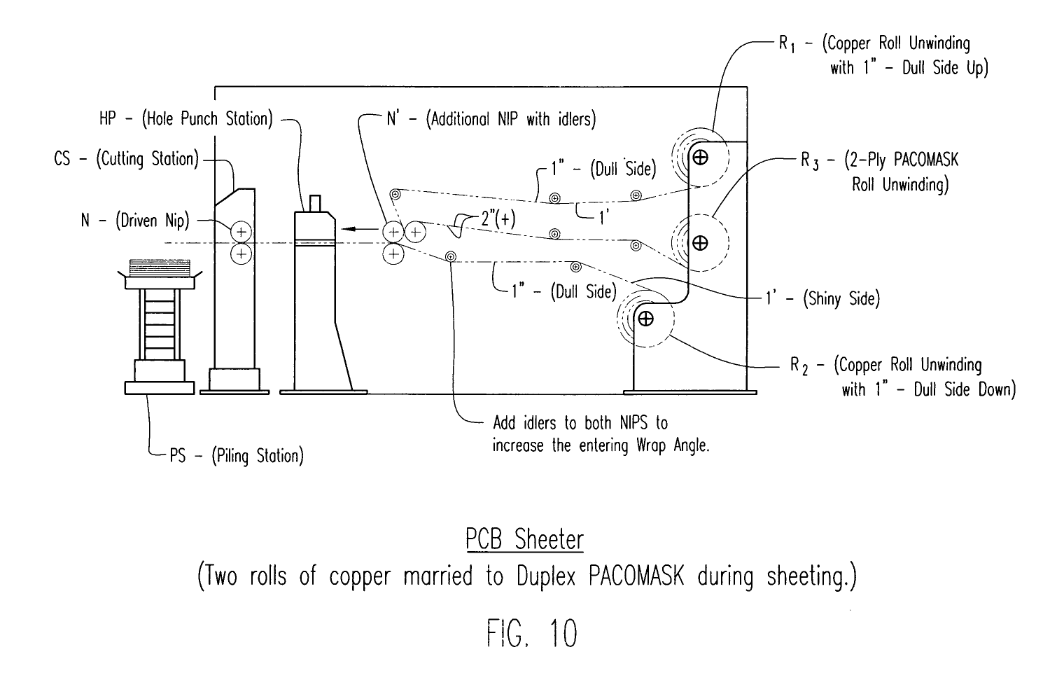

Alternatively, in the modification of FIG. 9, the upper ply charged PACOMASK layer 2″ (+) is first attached to the lower shiny surface 1′ of the upper copper foil web 1 at an earlier further nip N″, and then the lower ply charged layer 2″ (+) is nipped at N′ to the upper shiny surface 1′ of the lower copper foil web 1. In the further variant of FIG. 10, a three idler forward nip N′ is employed.

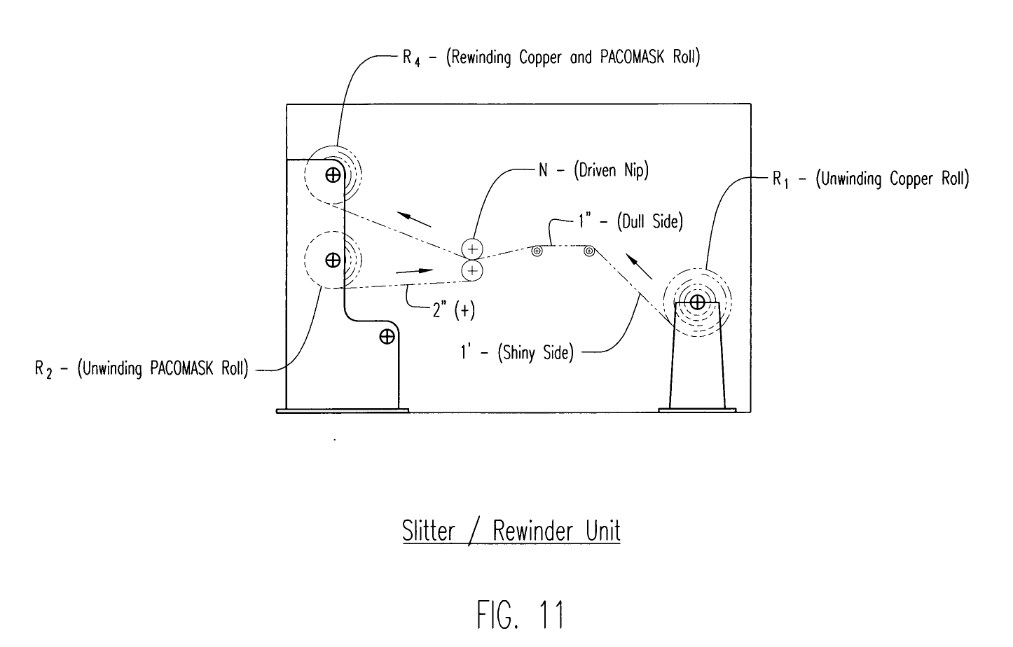

Finally, a modified slitter/rewinder, earlier described, is presented in FIG. 11 wherein the combined copper foil, lfrom unwind roll R₁ and PACOMASK roll 2 from roll R₂ are rewound on roll R₄.

Further modifications, including adaptation and use of the techniques and novel products of the invention with other types of substrate surfaces requiring protection or masking, will occur to those skilled in this art, and such are considered to fall within the spirit and scope of the invention as defined in the appended claims.

What is claimed is:

1. A method of protecting a smooth high finish shiny thin conducting copper foil with a protective masking insulating plastic film pre-treated over at least one of its opposite sides with a release surface, that comprises, electrostatically permanently charging said release surface while maintaining the opposite film side uncharged or neutral; laminating the film to the foil to charge-adhere the film release surface against the shiny foil; and subsequently, after the protection is no longer required, releasably stripping the film from the foil.

2. A method of protecting a smooth high finish shiny surface substrate, that comprises, electrostatically permanently charging one side only of a protective masking insulation plastic or paper film; applying the film upon the shiny substrate surface to charge-adhere the said one side of the film against said shiny substrate surface; and subsequently, after the protection is no longer required, stripping the film from the substrate surface.

3. The method of claim 1 wherein the film is a polyester plastic laminate having a coating of a thin release layer of a cured release acrylated/epoxy/urethane oligomer and/or oligomer blended resin on at least said one side of the film.

4. The method of claim 3 wherein said coating is applied to both sides of the film.

5. The method of claim 3 wherein the film side that is charge-adhered to the foil is smooth and the other side is relatively rougher.

6. The method of claim 3 wherein the film is substantially transparent.

7. The method of claim 3 wherein the film is selected from the group consisting of polyester, polypropylene, biaxially oriented polypropylene, polyvinylidine fluoride, polyethylene, paper and silicone TPX (polymethylpentene) and co-extruded films with releasable surface properties treated films.

8. The method of claim 1 wherein the copper foil and the protective film are provided in web rolls fed to a nipping station(s) for effecting said laminating charge-adhering.

9. The method of claim 8 wherein after said laminating charge-adhesion, the protected foil is cut into sheets and piled or stacked.

10. The method of claim 8 wherein said laminating charge-adhesion is effected during passage into sheeting apparatus.

11. The method of claim 1 wherein a pattern of pressure-sensitive adhesive material is applied on the charged film release surface.

12. The method of claim 11 wherein said pattern comprises one or more marginal strips applied along the edge(s) of the release surface.

13. The method of claim 11 wherein the electrostatic charging of said release surface is effected after the application thereto of the pressure-sensitive adhesive.

14. The method of claim 1 wherein said maintaining of the opposite film side uncharged or neutral during the charging is effected by interposing an intermediate conducting layer barrier.

15. The method of claim 14 wherein the film is formed as a composite of a pair of thin film plastic layers laminated together and carrying a metallized barrier layer.

16. The method of claim 15 wherein said metallized layer is provided on one or both of the pair of film plastic layers on their sides or surfaces adjacent their lamination.

17. Apparatus for producing a charge-attaching protective film or mask for a smooth high finish thin conducting copper foil as for PCB use, having, in combination, a plastic film web roll unwinding station; an electrostatic web-charging station; means for passing the unwinding film web through the web-charging station in a manner such as to charge only one side of the film web; a film-web roll rewinding station; and means for conveying the one-side charged film web from the web-charging station to the roll rewinding station.

18. The apparatus of claim 17 wherein the film-web roll rewinding station is provided with a plurality of roll rewinders, and a web slitter is interposed prior to the rewinders for slitting the one-side charged film web into a plurality of one-side charged film webs for conveying to the respective of the rewinders.

19. The apparatus of claim 17 wherein means is provided for laminating the one-side charged film from the rewind roll(s) to a web of thin copper foil.

20. The apparatus of claim 19 wherein sheeting apparatus is provided for cutting the laminated film-protected copper foil into sheets following such lamination.

21. A protected copper foil laminate product comprising a thin copper foil as for PCB use, having opposing shiny and dull surfaces, and laminated on the shiny surface of the foil with an inner permanently electrostatically charge-attached surface of a protective plastic film, the outer surface of which film is uncharged.

22. The product of claim 21 wherein the plastic film has a coating along its said inner surface of a charged thin release layer.

23. The product of claim 22 wherein the film is a polyester film, and a release layer coating is applied to both sides of the film of a cured release acrylated acrylated/epoxy/urethane oligomer and/or oligomer-blended resin.

24. The product of claim 22 wherein the release layer side that is charge-adhered to the foil is smooth and the other side is relatively rough.

25. The product of claim 21 wherein the film is substantially transparent.

26. The product of claim 21 wherein the film is selected from the group consisting of polyester, polypropylene, biaxially oriented polypropylene, polyvinylidine fluoride, paper and silicone TPX (polymethylpentene) and co-extruded films with releasable surface properties treated films.

27. The product of claim 22 wherein the charged release layer is providedwith at least one pressure-sensitive adhesive strip or lane.

28. The product of claim 27 wherein the adhesive strip or lane extends along one or more side edges of the film.

29. The product of claim 27 wherein the adhesive strip or lane is also electrically charged.

30. The product of claim 21 wherein the protective plastic film contains a conducting barrier layer that maintains the said outer film surface uncharged.

31. The product of claim 21 wherein the protective plastic film is a composite of a pair of thin plastic layers laminated together with a metallized barrier layer interposed.

32. The product of claim 31 wherein the plastic layers of the pair of layers are laminated with an interposed electron-beam cured adhesive.

33. The product of claim 31 wherein said metallized barrier layer is an aluminum coating deposited on one or both of the adjacent laminated sides or surfaces of the laminated pair of films.

34. The product of claim 21 wherein the inner film surface for charge-adhering to the shiny copper surface carriers a pattern of pressure-sensitive adhesive.

35. The product of claim 34 wherein said adhesive pattern extends along one or both edges of the film.

36. A thin plastic film product for protecting or masking the shiny surface of a thin copper foil as for PCB use, the film having an inner permanently electrostatically charged surface and an opposite outer surface that is electrically uncharged.

37. The product of claim 36 wherein the plastic film is a polyester film having a coating along its said inner surface of a charged thin release layer of a cured release acrylated/epoxy/urethane oligomer and/or oligomer-blended resin.

38. The product of claim 37 wherein said coating is applied to both surfaces of the film.

39. The product of claim 37 wherein the film surface that is charge-adhered to the foil is smooth and the outer surface is relatively rough.

40. The product of claim 36 wherein the film is substantially transparent.

41. The product of claim 36 wherein the film is selected from the group consisting of polyester, polypropylene, biaxially oriented polypropylene, polyethylene, polyvinylidine fluoride, paper and silicone TPX (polymethylpentene) and co-extruded films with releasable surface properties treated films.

42. The product of claim 36 wherein the plastic film is coated with a charged thin release layer over its said inner surface.

43. The product of claim 42 wherein the charged release coating surface is provided with at least one pressure-sensitive adhesive strip or lane.

44. The product of claim 43 wherein the adhesive strip or lane extends along one or more side edges of the film.

45. The product of claim 43 wherein the adhesive strip or lane is also electrically charged.

46. The product of claim 42 wherein the plastic film contains a conducting barrier layer that maintains the said outer film surface uncharged.

47. The product of claim 42 wherein the plastic film is a composite of a pair of thin plastic films laminated together with a metallized barrier layer interposed.

48. The product of claim 46 wherein the plastic layers of the pair of layers are laminated with an interposed electron-beam cured adhesive.

49. The product of claim 46 wherein said metallized barrier layer is an aluminum coating deposited on one or both of the adjacent laminated sides or surfaces of the laminated pair of films.

50. The product of claim 47 wherein the inner film surface for charge-adhering to the shiny copper surface carries a pattern of pressure-sensitive adhesive.

51. The product of claim 50 wherein said adhesive pattern is along one or both edges of the film.
